(19) United States
(12) Patent Application Publication
(10) Pub. No.: US 2008/0077712 A1
(43) Pub. Date: Mar. 27, 2008

(54) Peripheral device, peripheral-device recognizing method, and computer product

(75) Inventor: Kinya Saito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/711,793

(22) Filed: Feb. 28, 2007

(30) Foreign Application Priority Data
Sep. 27, 2006 (JP) 2006-263022

(51) Int. Cl. G06F 3/00

(52) U.S. Cl. 710/8

(57) ABSTRACT

An attribute-information storing unit stores therein attribute information about a real peripheral device that can be connected to a computer system. A connection responding unit returns a response indicating that the real peripheral device is actually connected to the computer system to a connection-check request from the computer system, based on the attribute information stored in the attribute-information storing unit.

### BACKGROUND OF THE INVENTION

1. Field of the Invention

The present invention generally relates to a technology for recognizing and connecting a virtual peripheral device corresponding to a real peripheral device in a computer system.

2. Description of the Related Art

Generally, a plurality of peripheral devices is connected to a computer system via a predetermined interface. An operating system (OS) of the computer system recognizes each of the peripheral devices as follows. A driver that is a control program for controlling the peripheral device under a control of the OS makes a query to the OS about a connection state of the peripheral device. The OS generates a device file based on its response to the query, and recognizes the peripheral device based on the generated device file.

Conventionally, the OS recognizes a peripheral device when the OS is booted, and, therefore, the OS needs to be rebooted every time when a new peripheral device is additionally connected to the computer system. Because it takes time to boot or reboot the OS, if the OS is rebooted every time when a new peripheral device is additionally connected, it is necessary to stop the computer system for a predetermined time, which is undesirable for operating the computer system.

To solve the disadvantages, a technology for recognizing the additionally connected peripheral device without the need to reboot the OS is disclosed, for example, in Japanese Patent Application Laid-Open No. 2000-173157. In the technology, when a peripheral device is additionally connected, connection information about the peripheral device, which is stored in a predetermined storing unit and with which the OS recognizes the peripheral device, is saved from the predetermined storing unit to a save area. After connection information about the additionally connected peripheral device is stored in the predetermined storing unit, the connection information saved in the save area is restored in the predetermined storing unit.

In the conventional technology disclosed in the Japanese Patent Application Laid-Open No. 2000-173157, the OS can advantageously recognize the peripheral device without being rebooted when the peripheral device is actually connected to the computer system. However, it is necessary to perform a process for recognizing the peripheral device, every time when the peripheral device is actually connected. Since the process takes time, there is a probability that the peripheral device cannot promptly be recognized by the OS. Furthermore, processing ability of the computer system is temporarily deteriorated because of the execution of the process.

Further, if the driver for the peripheral device has not been installed in the computer system when the peripheral device is connected to the computer system, a cumbersome process is required to install the driver. Moreover, the processing ability of the computer system is temporarily deteriorated due to the execution of the process for installing the driver. The above disadvantages are undesirable for the computer system required to continuously and stably operate.

Likewise, the plug and play function of the Windows® enables the OS to recognize the additionally connected peripheral device without rebooting the OS. However, the peripheral device is built in not previously but after being actually connected and then recognized by the OS. Therefore, various processes are executed in the OS, and the time for the execution of the processes is long. Specifically, if the driver for the peripheral device has not been installed in the computer system when the peripheral device is physically connected, the computer system turns into a standby state. The standby state continues until the driver is manually installed in the computer system. Accordingly, it is difficult for the OS to automatically recognize the peripheral device without time lag.

### SUMMARY OF THE INVENTION

It is an object of the present invention to at least partially solve the problems in the conventional technology.

A peripheral device according to one aspect of the present invention serves as a virtual peripheral device corresponding to a real peripheral device configured to be connected to a computer system. The peripheral device includes an attribute-information storing unit that stores therein attribute information about the real peripheral device that can be connected to the computer system; and a connection responding unit that returns a first response indicating that the real peripheral device is actually connected to the computer system to a connection-check request from the computer system, based on the attribute information stored in the attribute-information storing unit.

A method according to another aspect of the present invention is for recognizing a peripheral device that serves as a virtual peripheral device corresponding to a real peripheral device configured to be connected to a computer system. The method includes storing attribute information about the real peripheral device that can be connected to the computer system; and returning a first response indicating that the real peripheral device is actually connected to the computer system to a connection-check request from the computer system, based on the attribute information stored at the storing.

A computer-readable recording medium according to still another aspect of the present invention stores therein a computer program for recognizing a peripheral device that serves as a virtual peripheral device corresponding to a real peripheral device configured to be connected to a computer system. The computer program causes a computer to execute storing attribute information about the real peripheral device that can be connected to the computer system; and returning a first response indicating that the real peripheral device is actually connected to the computer system to a connection-check request from the computer system, based on the attribute information stored at the storing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1 to 3 are schematics for explaining a salient feature of a virtual-device response device according to a first embodiment of the present invention;

FIG. 4 is a functional block diagram of a virtual-device response system that includes the virtual-device response device shown in FIG. 1;

FIG. 5 is an example of the contents of virtual-device definition information for a small computer system interface (SCSI)-based interface (I/F) according to the first embodiment;

FIG. 6 is an example of the contents of the virtual-device definition information for a fiber channel (FC)-based I/F according to the first embodiment;

FIG. 7 is an example of the contents of a device-operation management table according to the first embodiment;

FIG. 8 is a timechart of a virtual-device recognition process performed by an operating system (OS) according to the first embodiment;

FIG. 9 is a timechart of a virtual-device recognition process performed by application software according to the first embodiment;

FIGS. 10 and 11 are timecharts of a real-device-operation recognition process performed by the application software according to the first embodiment; and

FIG. 12 is a functional block diagram of a virtual-device response system according to a second embodiment of the present invention.

### DETAILED DESCRIPTION OF THE PREFERRED EMBODIMENTS

Exemplary embodiments of the present invention are explained below in detail with reference to the accompanying drawings. In the embodiments, the present invention is applied to a virtual-device response device that is connectable to a tape library device, to which a plurality of tape drive devices is connectable, and that operates like a real tape drive for a host computer to which the tape library device is connected. However, the present invention is not thus limited and can be widely applied to peripheral devices externally connected to the host computer via a predetermined interface (I/F).

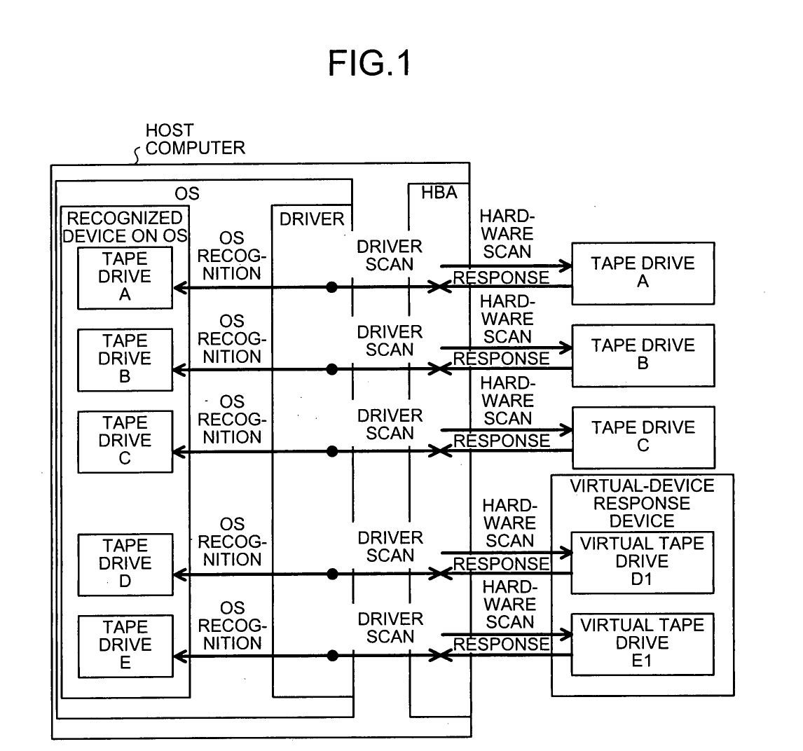

FIGS. 1 to 3 are schematics for explaining salient features of a virtual-device response device according to a first embodiment of the present invention. A tape-drive recognition performed by an operating system (OS) included in a host computer is explained with reference to FIG. 1. Tape drives A, B, and C are connected to a computer system controlled by the OS that includes a driver. The tape drives A, B, and C serve as peripheral devices actually connected to the computer system via a host bus adaptor (HBA). Furthermore, a virtual-device response device is connected to the computer system. The virtual-device response device is designed to serve as a virtual tape drive that operates like a real tape drive in relation to connection to the computer system. In the first embodiment, the virtual-device response device is designed to serve as virtual tape drives D1 and E1 that operate like real tape drives D2 and E2.

The HBA performs a hardware scan to each of the tape drives A to E. Each of the tape drives A to E returns each of responses to the hardware scan, and the HBA recognizes the response from each of the tape drives A to E. Thereafter, the driver performs a driver scan to the HBA for each of the tape drives A to E under control of the OS included in the computer system. When the driver performs the driver scan to the HBA for each of the tape drives A to E, the OS generates a device file with respect to each of the tape drives A to E and recognizes the tape drives A to E as “recognized” devices on the OS.

The tape drives A to C recognized by the OS are the real tape drives A to C actually connected to the computer system. On the other hand, the tape drives D and E recognized by the OS are connected to the computer system and recognized by the OS based on the responses from the virtual tape drives D1 and E1 as which the virtual-device response device is designed to serve.

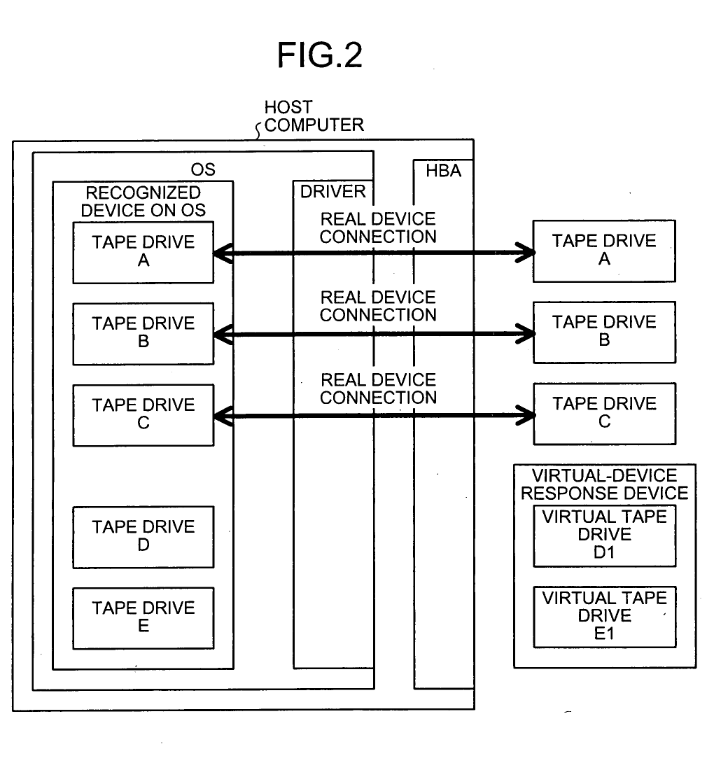

It is explained with reference to FIG. 2 how the tape drives A to C recognized by the OS of the host computer are connected as the real devices A to C to the computer system. After the tape drives A to C and the virtual tape drives D1 and E1 are recognized by the OS as shown in FIG. 1, the tape drives A to C are recognized as the real devices by the computer system, that is, as the “recognized” tape drives A to C on the OS. Further, the tape drives A to C are recognized by the OS that the tape drives A to C are in connection states in which they can transmit and receive data to and from the computer system. On the other hand, the virtual tape drives D1 and E1 are recognized as the tape drives D and E on the OS, but are not recognized as those in connection states in which they can transmit and receive data to and from the computer system.

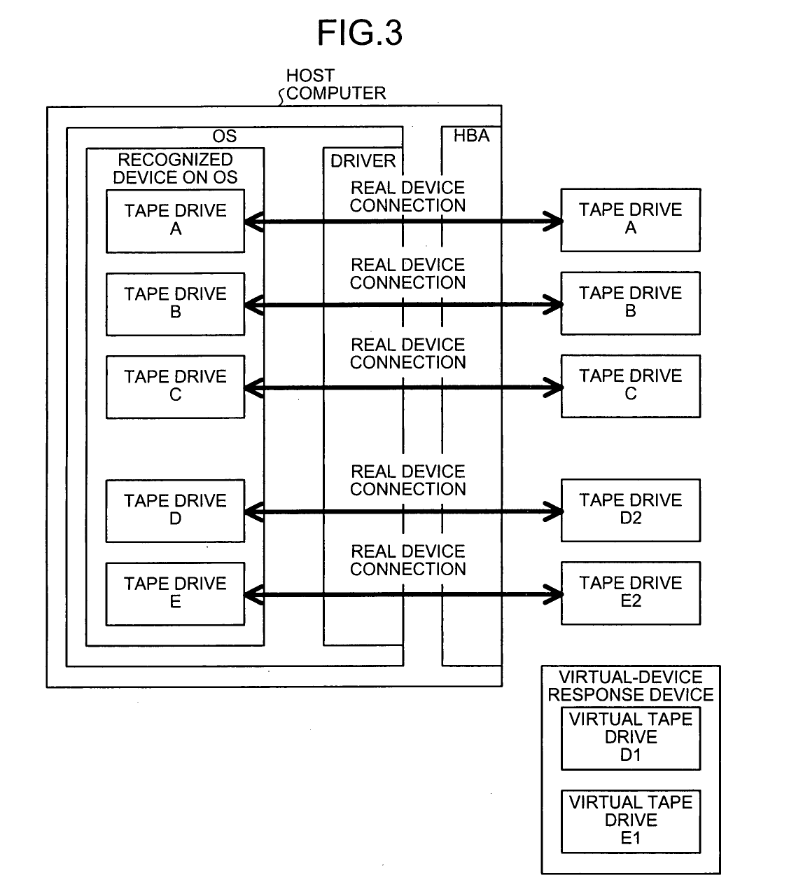

Next, it is explained with reference to FIG. 3 how the real tape drives D2 and E2 are connected to the computer system to correspond to the virtual tape drives D1 and E1 recognized by the OS of the host computer. As shown in FIG. 3, the tape drives A to C are previously connected as the real devices to the computer system. When the real tape drives D2 and E2 corresponding to the virtual tape drives D1 and E1 are actually connected to the computer system, the real tape drives D2 and E2 are connected to the computer system as the real devices. Accordingly, the virtual-device response device is irrelevant to the connection of the real tape drives D2 and E2 to the computer system.

Thus, the virtual-device response device operates similarly to the real tape drives D2 and E2 and is recognized as the virtual tape drives D1 and E1 by the OS of the host computer before the real tape drives D2 and E2 are actually recognized by the OS of the host computer. It is thereby possible to promptly start to use the tape drives D2 and E2 when the tape drives D2 and E2 are actually recognized by the OS of the host computer.

The feature explained above is characteristic of the present invention, as compared with the plug and play function of the Windows®. Namely, although the plug and play function also enables the OS to recognize additionally connected peripheral devices without rebooting the OS, the peripheral devices are built in the OS not previously but after being physically connected and then recognized by the OS. Therefore, with the plug and play function, there is a problem that various processes are interposed for being executed by the OS and the time for the execution of the processes is long. Specifically, with the Windows®, when the peripheral device is physically connected, if a device driver corresponding to the peripheral device is not installed in the computer system, the computer system turns into a standby state. The standby state continues until the driver is manually installed in the computer system. Accordingly, it is difficult for the OS to automatically recognize the peripheral device without time lag. On the contrary, according to the first embodiment, the OS executes such a time consuming process in advance, upon virtually recognizing the peripheral device. No time lag is, therefore, generated when the peripheral device is physically connected to the computer system.

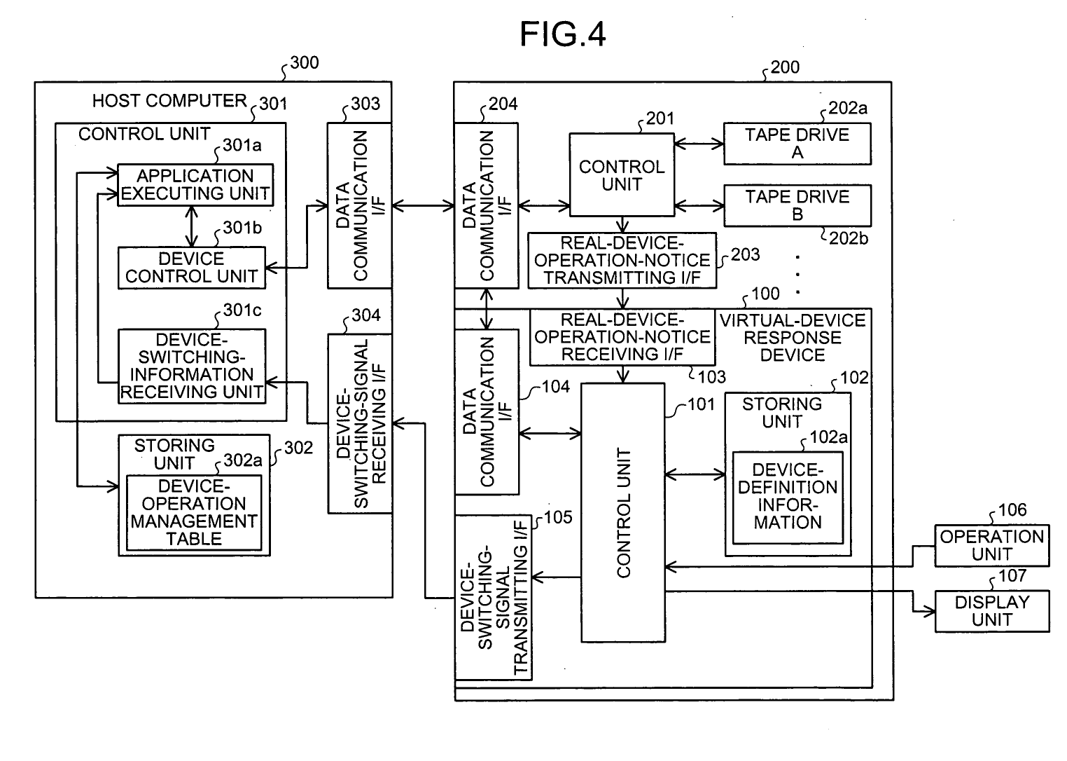

FIG. 4 is a functional block diagram of a virtual-device response system according to the first embodiment. As shown in FIG. 4, the virtual-device response system includes a tape library device 200, which includes a virtual-device response device 100, and a host computer 300.

The tape library device 200 includes a control unit 201, a plurality of tape drives represented by tape drives 202a and 202b in FIG. 4, a real-device-operation-notice transmitting I/F 203, a data communication I/F 204, and the virtual-device response device 100.

The control unit 201 controls the entirety of the tape library device 200. The control unit 201 transmits data and receives data to and from each of the tape drives, and notifies the virtual-device response device 100 that the tape drive has actually been connected to the computer system and started operating, via the real-device-operation-notice transmitting I/F 203. Further, the control unit 201 transmits and receives data to and from the data communication I/F 204 that relays the data transmitted and received between each of the tape drives and the host computer 300.

The virtual-device response device 100 includes a control unit 101, a storing unit 102, a real-device-operation-notice receiving I/F 103, a data communication I/F 104, and a device-switching-signal transmitting I/F 105.

The control unit 101 controls the entirety of the virtual-device response device 100. The control unit 101 reads out attribute-definition information that defines a device such as a tape drive designed to virtually respond to the host computer 300 and that is included in device-definition information 102a stored in the storing unit 102. The control unit 101 then determines a tape drive that responds as a virtual device based on the read attribute-definition information. Furthermore, the control unit 101 transmits the attribute-definition information about the tape drive that responds as the virtual device to the tape library device 200 via the data communication I/F 104. The tape library device 200 that has received the attribute-definition information via the data communication I/F 204 transmits the attribute-definition information to the host computer 300.

The control unit 101 receives information indicating that the tape drive has been actually connected and started operating, from the tape library device 200 via the real-device-operation-notice receiving I/F 103. Upon receiving the information indicating that the tape drive has been actually connected and started operating, the control unit 101 stops serving as the virtual tape drive.

The control unit 101 makes addition, modification or deletion of information with respect to the device-definition information 102a, based on the information input from an operation unit 106 such as a keyboard and a mouse. Further, the control unit 101 displays a part of or all of the device-definition information 102a onto a display unit 107 such as a display device, based on an instruction input form the operation unit 106, to enable effective addition, modification or deletion of information with respect to the device-definition information 102a.

The control unit 101 transmits a device switching signal based on the information, received from the tape library device 200 via the real-device-operation-notice receiving I/F 103, indicating that the tape drive has actually been connected and started operating, to the host computer 300 via the device-switching-signal transmitting I/F 105.

The host computer 300 includes a control unit 301, a storing unit 302, a data communication I/F 303, and a device-switching-signal receiving I/F 304. The control unit 301 controls the entirety of the host computer 300 and includes an application executing unit 301a, a device control unit 301b, and a device-switching-information receiving unit 301c.

The application executing unit 301a controls execution of application software. In the first embodiment, the application software is a tape backup application. If the peripheral device is other than the tape library device 200, application software suitable for a use of the other peripheral device can be employed.

The device control unit 301b controls various types of driver software. The device control unit 301b issues an inquiry command for the attribute information of the real or the virtual tape drive connected to the tape library device 200. The attribute information transmitted from the data communication I/F 303 is obtained by performing the hardware scan on the real or the virtual tape drive in response to a previous inquiry command. The device control unit 301b determines whether the real or the virtual tape drive is a target device for generating a device file and a target device for each of the driver software, and generates the device file. The real or the virtual tape drive is recognized as the device by the OS based on the device file.

The device-switching-information receiving unit 301c instructs the application executing unit 301a to start transmitting and receiving data to and from the real device connected to the host computer 300 based on the device-switching signal received from the virtual-device response device 100 via the device-switching-signal receiving I/F 304.

The storing unit 302 stores therein a computer program code of the application software to be executed by the application executing unit 301a, and the computer program code is read out if required to be executed by the application executing unit 301a. The storing unit 302 further stores therein a real-device-operation management table. In the real-device-operation management table, information for determining whether the device is virtually recognized by the application of the host computer 300 or whether the device is actually connected to the host computer 300 in an operable manner and recognized by the application of the host computer 300 is stored and managed.

Each of the data communication I/F 204 and the data communication I/F 303 can be either a small computer system interface (SCSI)-based I/F (hereinafter, “SCSI I/F”) or a fiber channel (FC)-based I/F (hereinafter, “FC I/F”). A communication between the device-switching-signal transmitting I/F 105 and the device-switching-signal receiving I/F 304 can be held by a desired connection such as a local area network (LAN) or a dedicated line. The data communication I/F 303 serves as the HBA.

The device-switching-information receiving unit 301c is an agent program that relays information which is transmitted from the virtual-device response device 100 and with which the application software enables the disabled hardware.

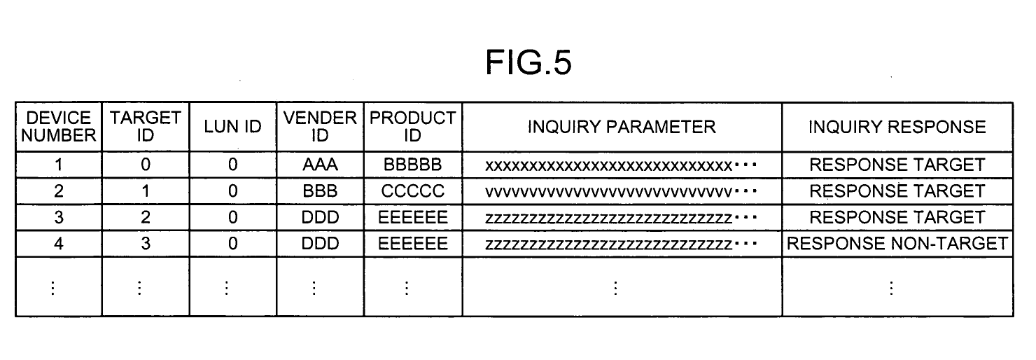

FIG. 5 is an example of the contents of the device-definition information 102a shown in FIG. 4, for explaining the virtual-device definition information if each of the data communication I/F 204 and the data communication I/F 303 is a SCSI I/F.

The virtual-device definition information for the SCSI I/F includes columns, as shown in FIG. 5, such as device number for uniquely identifying the device, target ID as identification information (SCSI-ID) for identifying the device on the SCSI, logical unit number (LUN) ID as an address assigned for identifying a logic unit configuration if a single target ID includes a plurality of the logic unit configurations, vender ID for identifying a manufacturer of the device, product ID for identifying a product, inquiry parameter that stores therein the inquiry parameter itself, and inquiry response that indicates whether or not the device is an inquiry-response target.

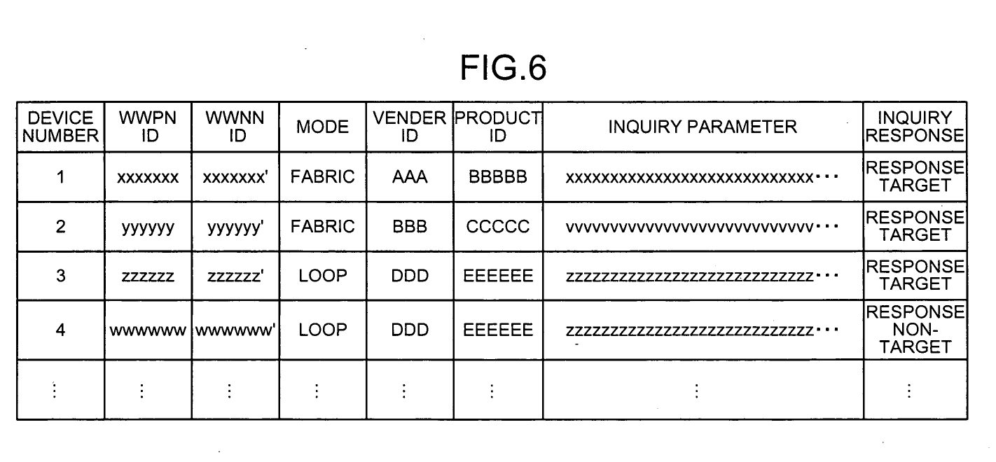

FIG. 6 is an example of the contents of the device-definition information 102a shown in FIG. 4, for explaining the virtual-device definition information if each of the data communication I/F 204 and the data communication I/F303 is an FC I/F.

The virtual-device definition information for the FC I/F includes columns, as shown in FIG. 6, such as the device ID for uniquely identifying the device, world wide port names (WWPN) ID for identifying a port on the FC, world wide node name (WWNN) ID for identifying a node on the FC, mode that indicates a network configuration of the FC, the vender ID for identifying a manufacturer of the device, the product ID for identifying a product, the inquiry parameter that stores therein the inquiry parameter itself, and the inquiry response that indicates whether or not the device is an inquiry-response target.

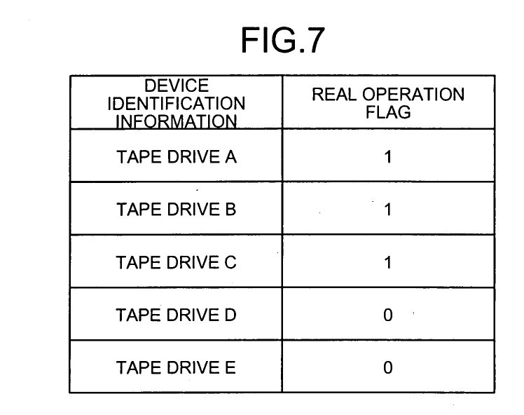

FIG. 7 is an example of the contents of a device-operation management table 302a. In the device-operation management table 302a, information for determining whether the device is virtually recognized by the application of the host computer 300 or whether the device is actually connected in the operable manner and recognized by the application of the host computer 300 is stored and managed. The device-operation management table 302a is used to manage an operation state of the real device with respect to each application to be executed on the host computer 300.

The device-operation management table 302a includes columns such as device identification information and real operation flag. The device identification information is for uniquely identifying the peripheral device. The real operation flag indicates a state of the device. That is, if the real operation flag is “1” (turned on), it is indicated that the device is not virtually connected and recognized but is actually connected in the operable manner. If the flag is “0” (turned off), it is indicated that the device is not actually connected in the operable manner but is virtually recognized and connected.

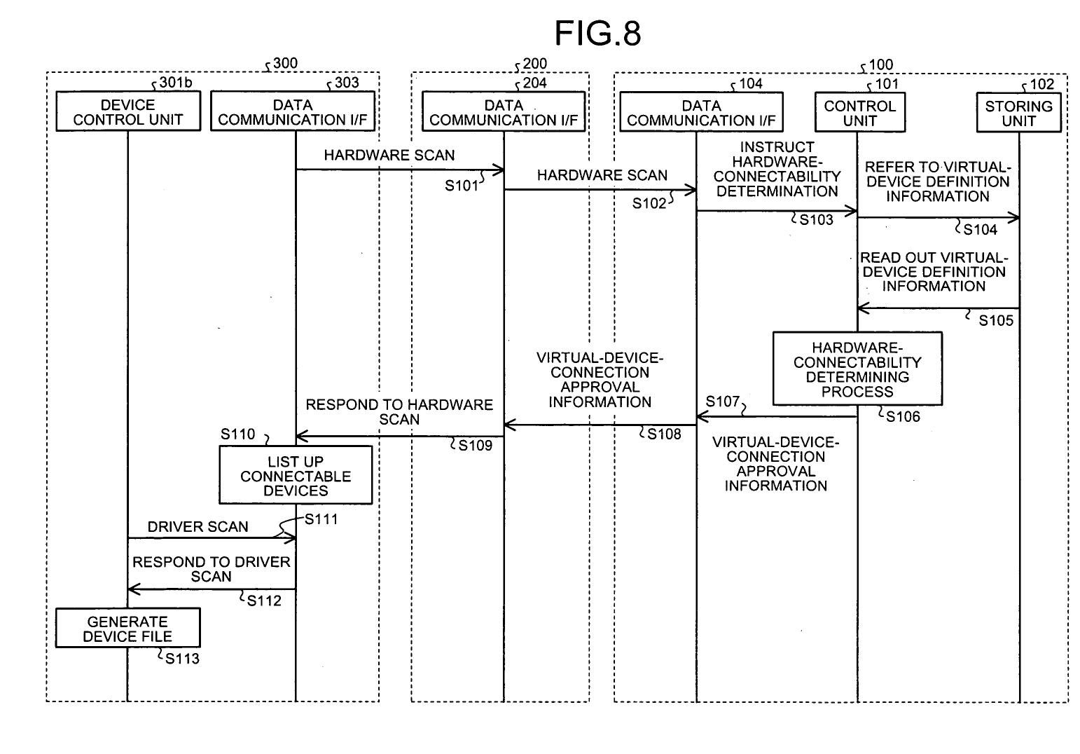

FIG. 8 is a timechart of the virtual-device recognition process performed by the OS in the virtual-device response system shown in FIG. 4. As shown in FIG. 8, the data communication I/F 303 of the host computer 300 performs the hardware scan to the data communication I/F 204 of the tape library device 200 (step S101), and also to the data communication I/F 104 of the virtual-device response device 100 (step S102).

In the virtual-device response device 100, the data communication I/F 104 transmits a hardware-connectability determination instruction to the control unit 101 (step S103). The control unit 101 transmits an instruction for referring to the virtual-device definition information to the storing unit 102 (step S104), and reads the virtual-device definition information from the storing unit 102 (step S105).

After reading the virtual-device definition information, the control unit 101 executes a hardware-connectability determination process (step S106). If it is determined that the hardware is connectable to the host computer 300 as a result of the hardware-connectability determination process, the control unit 101 transmits virtual-device-connection approval information indicating that the target device is connectable as the virtual device to the data communication I/F 104 (step S107). The data communication I/F 104 transmits the virtual-device-connection approval information to the data communication I/F 204 of the tape library device 200 (step S108).

Upon receiving the virtual-device-connection approval information, the tape library device 200 transmits a response to the hardware scan performed at step S101, to the data communication I/F 303 of the host computer 300 (step S109). The data communication I/F 303 that has received the response adds the hardware to a connectable device (hardware) list (step S110).

In the host computer 300, the device control unit 301b performs the driver scan to the data communication I/F 303 (step S111). In response to the driver scan, the data communication I/F 303 determines whether the device is added to the connectable device list at step S110 and transmits a determination result as a driver-scan response to the device control unit 301b (step S112). Upon receiving the driver-scan response, the device control unit 301b generates the device file corresponding to the hardware (step S113). The hardware is recognized by the OS based on the generated device file.

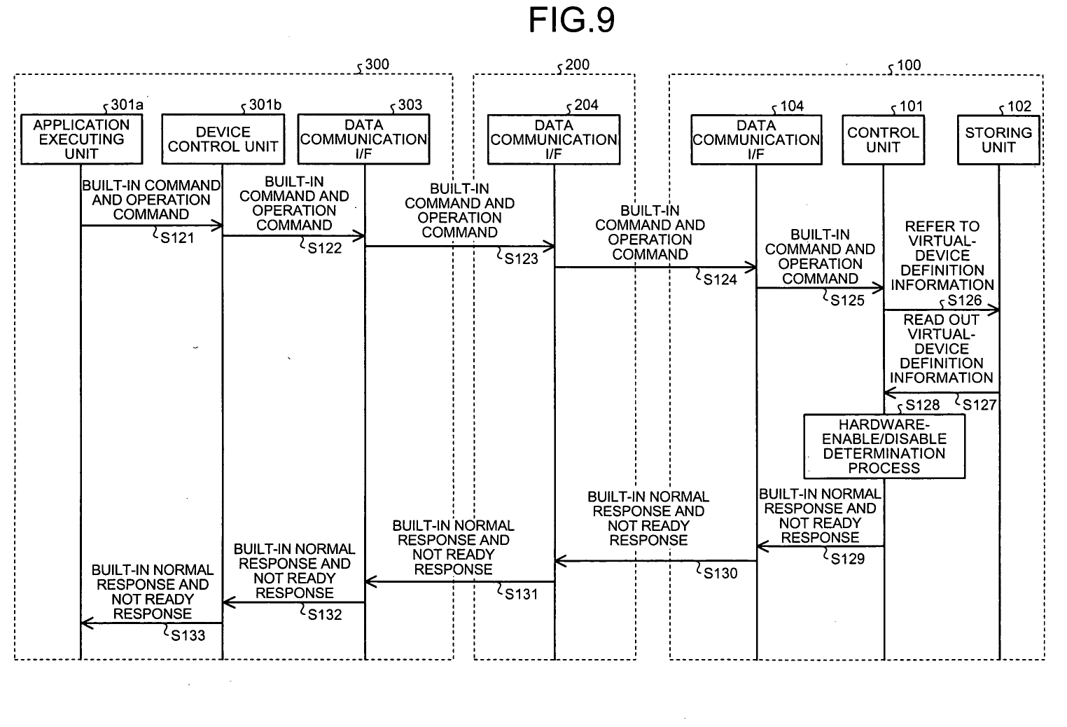

FIG. 9 is a timechart of the virtual-device recognition process for recognizing the hardware as the peripheral device, performed by application software on the host computer 300. As shown in FIG. 9, in the host computer 300, a built-in command and a real operation command are transmitted from the application executing unit 301a to the device control unit 301b (step S121). Thereafter, upon receiving the built-in command and the real operation command from the application executing unit 301a, the device control unit 301b transmits the built-in command and the real operation command to the data communication I/F 303 (step S122). The built-in command is a command for determining whether the hardware is properly recognized and built in the application software. The real operation command is a command for determining whether the hardware is physically connected to the host computer and on a standby state for operating the application software.

Upon receiving the built-in command and the real operation command, the data communication I/F 303 of the host computer 300, transmits the built-in command and the real operation command to the data communication I/F 204 of the tape library device 200 (step S123).

Upon receiving the built-in command and the real operation command, the data communication I/F 204 of the tape library device 200 transmits the built-in command and the real operation command to the data communication I/F 104 of the virtual-device response device 100 (step S124).

Upon receiving the built-in command and the real operation command, the data communication I/F 104 of the virtual-device response device 100 transmits the built-in command and the real operation command to the control unit 101 in the virtual-device response device 100 (step S125). Upon receiving the built-in command and the real operation command, the control unit 101 refers to the virtual-device definition information in the storing unit 102 (step S126). By referring to the virtual-device definition information, the control unit 101 reads out the virtual-device definition information from the storing unit 102 (step S127). The control unit 101 determines whether the hardware is enabled (whether the virtual-device-definition is registered) based on the read virtual-device definition information (step S128).

If it is determined that the hardware is enabled based on a process performed at step S128, the control unit 101 transmits a built-in normal response and a not ready response to the data communication I/F 104 (step S129). The built-in normal response is a return to the built-in command and indicates that the hardware is properly recognized and built in the application software. The not ready response is a return to the real operation command and indicates a standby state in which the hardware is physically connected to the host computer but is not logically connected for enabling the application software.

Upon receiving the built-in normal response and the not ready response, the data communication I/F 104 transmits the built-in normal response and the not ready response to the data communication I/F 204 of the tape library device 200 (step S130).

Upon receiving the built-in normal response and the not ready response, the data communication I/F 204 transmits the built-in normal response and the not ready response to the data communication I/F 303 of the host computer 300 (step S131).

Upon receiving the built-in normal response and the not ready response, the data communication I/F 303 of the host computer 300 transmits the built-in normal response and the not ready response to the device control unit 301b (step S132).

Upon receiving the built-in normal response and the not ready response, the device control unit 301b transmits the built-in normal response and the not ready response to the application executing unit 301a (step S133). In this manner, in response to the built-in command and the real operation command transmitted from the application executing unit 301a of the host computer 300 to the virtual-device response device 100, the virtual-device response device 100 returns the built-in normal response and the not ready response to the application executing unit 301a of the host computer 300. Accordingly, the application software recognizes the virtual-device response device 100 and is notified that the virtual-device response device 100 is physically connected to the host computer but not logically connected to enable the application software, between the tape drive designed as which the virtual-device response device 100 virtually serves and the application software.

If it is determined that the hardware is disabled based on the process performed at step S128, the processes from S129 to S133 are not performed.

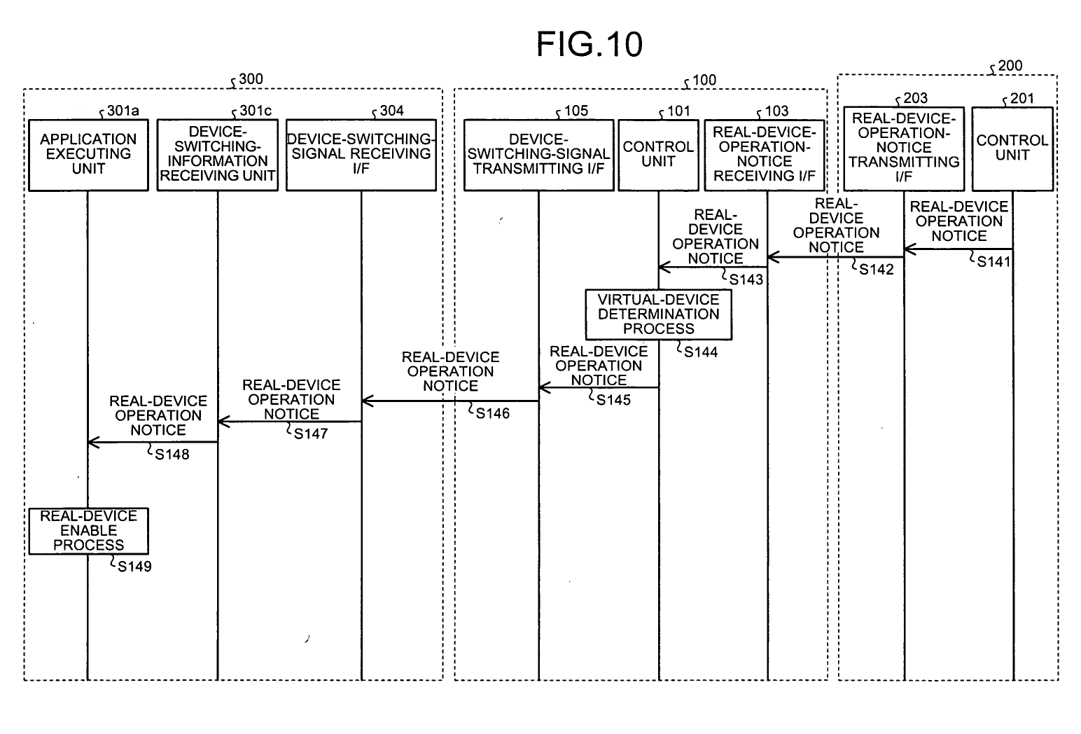

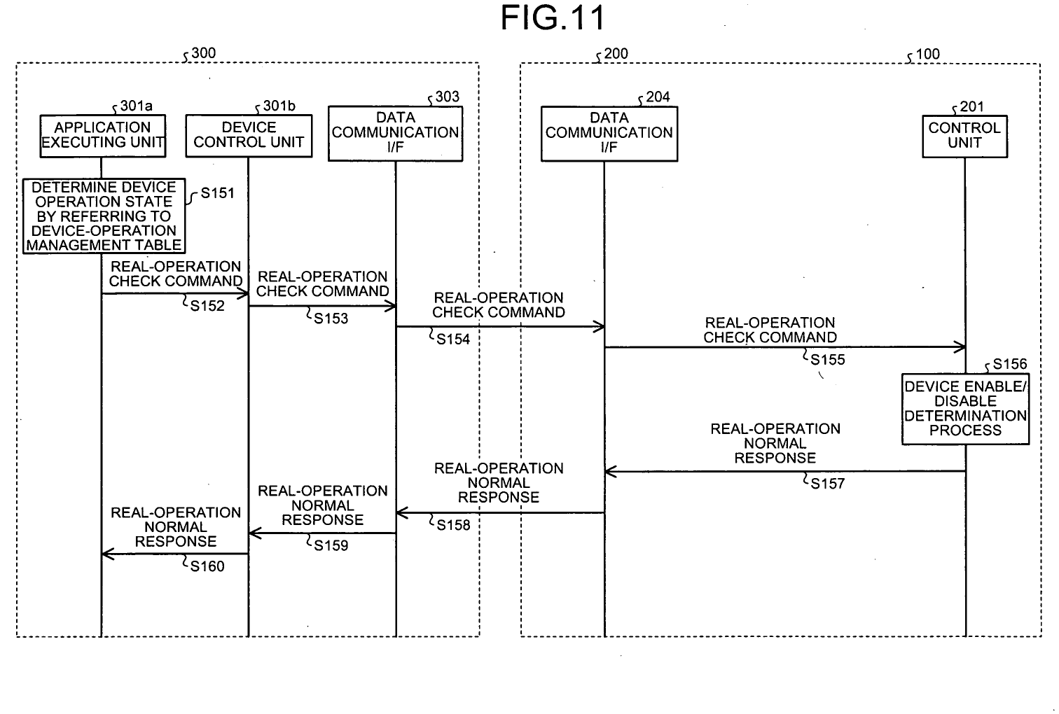

FIGS. 10 and 11 are timecharts of a process procedure of a real-device-operation recognition process according to the first embodiment. The real-device-operation recognition process is executed when the hardware as the peripheral device that has virtually been recognized on the host computer 300 by the virtual-device response device 100 is actually connected and starts operating. The process shown in FIG. 10 is an interrupt process performed when the real device corresponding to the virtual device is actually connected and starts operating. The process shown in FIG. 11 is a polling process that determines the real operation flag by periodically referring to the device-operation management table 302a and performs a connection check of the real device when the real operation flag is “1” (turned on) according to the determination.

As shown in FIG. 10, in the tape library device 200, if the control unit 201 detects that the hardware virtually connected to and recognized by the host computer 300 has started operating, the control unit 201 transmits the real-device operation notice to the real-device-operation-notice transmitting I/F 203 (step S141).

Upon receiving the real-device operation notice, the real-device-operation-notice transmitting I/F 203 transmits the real-device operation notice to the real-device-operation-notice receiving I/F 103 of the virtual-device response device 100 (step S142).

Upon receiving the real-device operation notice, the real-device-operation-notice receiving I/F 103 of the virtual-device response device 100 transmits the real-device operation notice to the control unit 101 (step S143). Upon receiving the real-device operation notice, the control unit 101 performs the virtual-device determination process in a determination process specified by the real-device operation notice and performed by the operation device (step S144). Thereafter, the control unit 101 transmits the real-device operation notice as an operation notice of the real device corresponding to the virtual device determined at step S144 to the device-switching-signal transmitting I/F 105 (step S145). Upon receiving the real-device operation notice, the device-switching-signal transmitting I/F 105 transmits the real-device operation notice to the device-switching-signal receiving I/F 304 of the host computer 300 (step S146).

Upon receiving the real-device operation notice, the device-switching-signal receiving I/F 304 of the host computer 300 transmits the real-device operation notice to the device-switching-information receiving unit 301c (step S147). Upon receiving the real-device operation notice, the device-switching-information receiving unit 301c transmits the real-device operation notice to the application executing unit 301a (step S148). Upon receiving the real-device operation notice, the application executing unit 301a sets the real operation flag of the real device to “1” (turned on) (step S149). In this manner, the host computer 300 is notified that the hardware that had virtually been recognized by the application software has physically and logically been connected and started operating, by the tape library device 200.

At step S149, the application executing unit 301a receives the real-device operation notice and sets the real operation flag of the real device to “1” (turned on). However, the present invention is not thus limited and it is acceptable that the OS or other application software receives the real-device operation notice and sets the real operation flag of the real device to “1” (turned on). In other words, it is acceptable that the OS or the other application software receives a notice of the operation of the real device and manages the operation of the real device.

As shown in FIG. 11, the application executing unit 301a of the host computer 300 determines an operation state of the device by referring to the column of the real operation flag in the device-operation management table 302a (step S151). The application executing unit 301a transmits a real-operation check command to the device control unit 301b in the host computer 300 (step S152). Upon receiving the real-operation check command from the application executing unit 301a, the device control unit 301b transmits the real-operation check command to the data communication I/F 303 (step S153).

Upon receiving the real-operation check command, the data communication I/F 303 of the host computer transmits the real-operation check command to the data communication I/F 204 of the tape library device 200 (step S154).

Upon receiving the real-operation check command, the data communication I/F 204 of the tape library device 200 transmits the real-operation check command to the control unit 201 (step S155). Upon receiving the real-operation check command, the control unit 201 determines whether the hardware is enabled (step S156).

Thereafter, the control unit 201 transmits the real-operation normal response to the data communication I/F 204 (step S157). The real-operation normal response is a return to the real operation command and indicates that the hardware is enabled in a data-communicable manner by the application software.

Upon receiving the real-operation normal response, the data communication I/F 204 transmits the real-operation normal response to the data communication I/F 303 of the host computer 300 (step S158).

Upon receiving the real-operation normal response, the data communication I/F 303 of the host computer 300 transmits the real-operation normal response to the device control unit 301b (step S159).

Upon receiving the real-operation normal response, the device control unit 301b transmits the real-operation normal response to the application executing unit 301a (step S160). In this manner, in response to the real-operation check command transmitted from the application executing unit 301a of the host computer 300 to the tape library device 200, the tape library device 200 transmits the real-operation normal response to the application executing unit 301a of the host computer 300. Accordingly, the application software recognizes the tape drive and is notified that the tape drive and the application software have logically been connected but data communication has still not been performed.

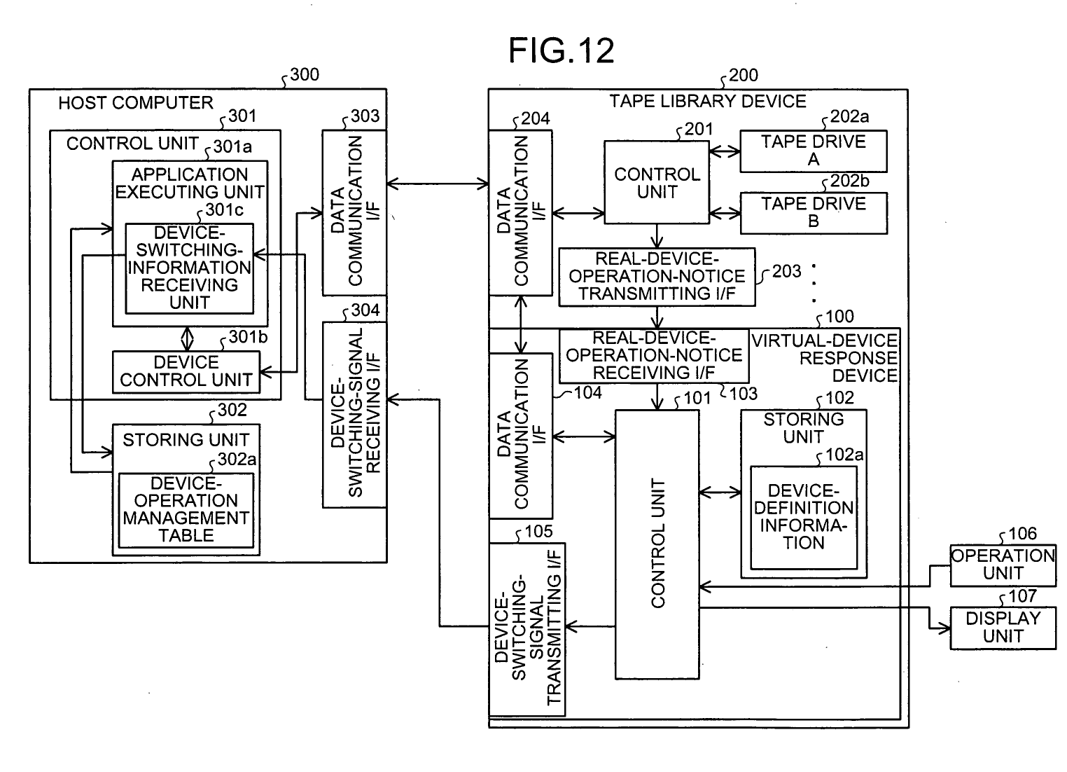

FIG. 12 is a functional block diagram of a virtual-device response system according to a second embodiment of the present invention. As shown in FIG. 12, it is acceptable to configure so that the device-switching-information receiving unit 301c is included in the application executing unit 301a. In this case, the device-switching-information receiving unit 301c receives a command that enables the hardware on which the application software has been disabled, from the virtual-device response device 100. Upon receiving the command, the device-switching-information receiving unit 301c sets the real operation flag of the device to “1” (turned on) in the device-operation management table 302a in the storing unit 302. The other constituent components are the same as those shown in FIG. 4.

According to the above embodiments, even when the tape drive is not a real device, if the tape drive is to be used in the future, the tape drive can virtually be recognized by the OS and the application software of the host computer 300. Accordingly, when the tape drive is actually connected and starts operating, because the tape drive has already been recognized, it is not required to reboot the OS and to perform processes related to the recognition of the tape drive. Therefore, the processing ability of the host computer 300 is not temporarily deteriorated.

Further, when the tape drive is connected to the host computer, it is possible for the tape drive to promptly be connected to the host computer and start operating.

The processes explained in the above embodiments can be realized by executing previously set computer programs by a computer system, such as a personal computer, server, or a workstation, connectable to the peripheral device.

According to an embodiment of the present invention, the device to be connected in the future can virtually be recognized as the virtual device in addition to the device actually connected in an operable manner, and the processes related to the recognition performed by the OS can be completed when the virtual device is recognized. Accordingly, when the virtually recognized device is actually connected, it is not required for the OS to perform the process related to the recognition, and, therefore, it is possible for the device to promptly start operating.

Further, according to an embodiment of the present invention, acceptable devices to be connected to the host computer in addition to the devices actually connected in the operable manner are previously determined as the virtual devices. Accordingly, it is possible to improve the operation management. That is, it is possible to prevent the devices of the number exceeded from the determined number from being connected, or devices other than the predetermined devices from being connected.

The present invention in its broader aspects is not limited to the specific details and representative embodiments shown and described herein. Accordingly, various modifications can be made without departing from the spirit or scope of the general inventive concept as defined by the appended claims and their equivalents. Further, the effects described in the embodiments are not to be thus limited.

For example, according to the above embodiments, the data communication I/F 104 of the virtual-device response device 100 is connected to the data communication I/F 204 of the tape library device 200, the data communication I/F 204 is connected to the data communication I/F 303 of the host computer 300, so that the virtual-device response device 100 is communicably connected to the host computer 300. However, the data communication I/F 104 of the virtual-device response device 100 can directly be connected to the data communication I/F 303 of the host computer 300 to communicably connect the virtual-device response device 100 to the host computer 300.

Further, according to the above embodiments, the virtual-device response device 100 is accommodated in the tape library device 200. However, the virtual-device response device 100 can be arranged outside the tape library device 200 and connected to the tape library device 200. In this case, the virtual-device response device 100 can be connected adjacent to the host computer 300 if each of the peripheral devices are connected with one another in the daisy chain, or can be connected in any order in the daisy chain.

As described above, according to one aspect of the present invention, a peripheral device that is not logically connected can virtually be connected and recognized by the computer system. This is because the computer system performs a connection-check request to the peripheral device, and the peripheral device returns a response indicating that the peripheral device is physically connected to the computer system, to its request, based on the attribute information on the peripheral device, which is stored in the attribute-information storing unit.

Furthermore, according to another aspect of the present invention, the peripheral device can recognize when the peripheral device virtually connected and recognized by the computer system is logically connected.

Moreover, according to still another aspect of the present invention, the peripheral device can cause the computer system to recognize when the peripheral device virtually connected and recognized by the computer system is logically connected.

Furthermore, according to still another aspect of the present invention, it is possible to prevent an erroneous operation caused by a confusion of the processes. This is because the peripheral device does not respond as the logically connected peripheral device that enables communication, when the peripheral device that has virtually been connected and recognized is built in the computer system.

Moreover, according to still another aspect of the present invention, it is possible to notify the application on the computer system of a state in which the peripheral device is on standby and can be turned into a state in which the data communication is enabled.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A peripheral device that serves as a virtual peripheral device corresponding to a real peripheral device configured to be connected to a computer system, the peripheral device comprising:
an attribute-information storing unit that stores therein attribute information about the real peripheral device that can be connected to the computer system; and
a connection responding unit that returns a first response indicating that the real peripheral device is actually connected to the computer system to a connection-check request from the computer system, based on the attribute information stored in the attribute-information storing unit.

2. The peripheral device according to claim 1, further comprising a connection-notice receiving unit that receives a connection notice indicating that the real peripheral device for which the first response was returned has been actually connected to the computer system.

3. The peripheral device according to claim 2, further comprising a connection notifying unit that notifies the computer system of a connection of the real peripheral device, upon the connection-notice receiving unit receiving the connection notice.

4. The peripheral device according to claim 2, wherein the connection responding unit does not return the first response to the connection-check request, upon the connection-notice receiving unit receiving the connection notice.

5. The peripheral device according to claim 1, further comprising a standby responding unit that returns a second response indicating that the real peripheral device for which the first response was returned is on standby for the computer system to a connection-check request from an application executed on the computer system.

6. The peripheral device according to claim 5, further comprising a connection notifying unit that notifies the application of a connection of the real peripheral device, upon the real peripheral device for which the first response was returned being actually connected to the computer system.

7. The peripheral device according to claim 5, further comprising a connection-notice receiving unit that receives a connection notice indicating that the real peripheral device for which the first response was returned has been actually connected to the computer system, wherein
the connection responding unit does not return the first response to the-connection check request from the application, upon the connection-notice receiving unit receiving the connection notice.

8. The peripheral device according to claim 1, further comprising:
an input receiving unit that receives an input of the attribute information; and
a display unit that displays a list of attribute information stored in the storing unit.

9. A method of recognizing a peripheral device that serves as a virtual peripheral device corresponding to a real peripheral device configured to be connected to a computer system, the method comprising:
storing attribute information about the real peripheral device that can be connected to the computer system; and
returning a first response indicating that the real peripheral device is actually connected to the computer system to a connection-check request from the computer system, based on the attribute information stored at the storing.

10. The method according to claim 9, further comprising returning a second response indicating that the real peripheral device for which the first response was returned is on standby for the computer system to a connection-check request from an application executed on the computer system.

11. A computer-readable recording medium that stores therein a computer program for recognizing a peripheral device that serves as a virtual peripheral device corresponding to a real peripheral device configured to be connected to a computer system, the computer program causing a computer to execute:
storing attribute information about the real peripheral device that can be connected to the computer system; and
returning a first response indicating that the real peripheral device is actually connected to the computer system to a connection-check request from the computer system, based on the attribute information stored at the storing.

12. The computer-readable recording medium according to claim 11, further comprising receiving a connection notice indicating that the real peripheral device for which the first response was returned has been actually connected to the computer system.

13. The computer-readable recording medium according to claim 12, further comprising notifying the computer system of a connection of the real peripheral device, when the connection notice is received.

14. The computer-readable recording medium according to claim 12, wherein the returning a first response includes not returning the first response to the connection-check request, when the connection notice is received.

15. The computer-readable recording medium according to claim 11, further comprising returning a second response indicating that the real peripheral device for which the first response was returned is on standby for the computer system to a connection-check request from an application executed on the computer system.

16. The computer-readable recording medium according to claim 15, further comprising notifying the application of a connection of the real peripheral device, when the real peripheral device for which the first response was returned is actually connected to the computer system.

17. The computer-readable recording medium according to claim 15, further comprising receiving a connection notice indicating that the real peripheral device for which the first response was returned has been actually connected to the computer system, wherein
the returning a first response includes not returning the first response to the-connection check request from the application, when the connection notice is received.

18. The computer-readable recording medium according to claim 11, further comprising:
receiving an input of the attribute information; and
displaying a list of attribute information stored at the storing.
